(19) United States
(12) Patent Application Publication
(10) Pub. No.: US 2020/0335978 A1
(43) Pub. Date: Oct. 22, 2020

(54) Adaptive Control Method for Output Feedback of Virtual Synchronous Generator

(71) Applicant: Xi'an University of Technology, Xi'an (CN)

(72) Inventors: Haipeng REN, Xi'an (CN); Jie LI, Xi'an (CN)

(21) Appl. No.: 16/842,816

(22) Filed: Apr. 8, 2020

(30) Foreign Application Priority Data
Apr. 16, 2019 (CN) 201910304932.8

(51) Int. Cl. H02J 3/48; H02J 3/38

(52) U.S. Cl. CPC H02J 3/48; H02J 3/381; H02J 2300/20; H02J 2203/10; H02J 2203/20

(57) ABSTRACT

The present disclosure discloses an adaptive control method for an output feedback of a VSG. The method includes: analog signals are converted to digital values; VSG excitation output by reactive power-voltage regulation control is calculated, and an output voltage amplitude and a grid voltage amplitude of a three-phase full-bridge inverter are calculated; an active power, a reactive power and an excitation electromotive force are calculated; an initial value of speed feedback coefficient is calculated; angular speed and phase are output, and a rotation speed difference and an angular acceleration are calculated; the speed feedback coefficient is set according to the rotation speed difference; the CLARK transform is performed by means of the excitation electromotive force to obtain a voltage in an α-β stationary coordinate system; and SVPWM is performed to obtain a six-way switch control pulse driving the three-phase full-bridge inverter and implement a three-phase AC current feedback grid.

### CROSS-REFERENCE TO RELATED APPLICATIONS

The present disclosure claims priority of Chinese Patent Application No. 201910304932.8, filed to China Patent Office on Apr. 16, 2019. Contents of the present disclosure are hereby incorporated by reference in entirety of the Chinese Patent Application.

### TECHNICAL FIELD

The present disclosure relates to the technical field of grid connection control of renewable energy generation, and in particular to an adaptive control method for an output feedback of a Virtual Synchronous Generator (VSG).

### BACKGROUND

With the massive construction of power generation systems adopting new energy sources with intermittent characteristic, such as solar energy and wind energy, these new energy sources access to the grid through a power electronic converter, and these intermittent energy sources bring about great challenges to the stability of the grid due to the lack of the inertia of a conventional generator. A VSG technology provides a conventional three-phase inverter with external characteristics of a similar synchronous generator, and improves the stability of new energy sources accessing to the grid, therefore the VSG technology receives extensive attentions in recent years. Parameter selection of the VSG directly influences a performance of a system. Since a power electronic device has strict requirements for a transient response of the system, in order to optimize a transient process, people put forward some adaptive adjustment strategies for the parameters of the VSG.

At present, adaptive adjustment parameters are mainly a damping droop coefficient Dₚ and a virtual moment of inertia J. Existing problems of these adaptive adjustment parameters is in a transient regulation process, an extensive adjustment to the damping droop coefficient Dₚ and the virtual moment of inertia J is performed to realize the complete inhibition of frequency fluctuation and power overshoot, which requires the system to have a high energy storage margin.

### SUMMARY

At least some embodiments of present disclosure provide an adaptive control method for an output feedback of a VSG, so as at least to partially solve a problem in the related art that in a transient regulation process, an extensive adjustment to the damping droop coefficient Dₚ and the virtual moment of inertia J is performed to realize the complete inhibition of frequency fluctuation and power overshoot, which requires the system to have a high energy storage margin.

In an embodiment of the present disclosure an adaptive control method for an output feedback of a VSG is provided, which is implemented according to the following steps.

At Step 1, output currents, output voltages and grid voltages of a three-phase full-bridge inverter are acquired through a current sensor and a voltage sensor, and analog signals are converted to digital values iₐ, i_{b} and i_{c} corresponding to the output currents, digital values uₒₐ, u_{ob} and u_{oc} corresponding to the output voltages, and digital values u_{ga}, u_{gb} and u_{gc} corresponding to the grid voltages.

At Step 2, VSG excitation M_{f}i_{f} output by inactive power-voltage regulation control is calculated, and an output voltage amplitude uₒ and a grid voltage amplitude u_{g} of the three-phase full-bridge inverter are calculated.

At Step 3, an active power Pₑ, a reactive power Qₑ and an excitation electromotive force e output by the VSG are calculated.

At Step 4, speed feedback control is performed, and an initial value Kₜ of a speed feedback coefficient is calculated.

At Step 5, active power-frequency modulation control is implemented, a angular speed ω and a phase of the VSG are output, and a rotation speed difference Δω and an angular acceleration

$$\frac{d ω}{dt}$$

of the VSG are calculated.

The angular acceleration

$$\frac{d ω}{dt}$$

of the VSG is obtained according to the formula (8); the angular acceleration

$$\frac{d ω}{dt}$$

of the VSG is integrated to obtain the angular speed ω of the VSG, and then the angular speed ω of the VSG is integrated to obtain the phase θ of the VSG;

$$\frac{d ω}{dt} = \frac{\frac{{P}_{m }^{′}}{{ω}_{0}} - {D}_{p} ( ω - {ω}_{0} )}{J} = \frac{\frac{{P}_{m}^{′}}{{ω}_{0}} - {T}_{d}}{J} = \frac{Δ T}{J} \qquad ( 8 )$$

and a damping torque T_{d}=Dₚ(ω−ω₀), and a torque variation ΔT is obtained by subtracting the damping torque T_{d} from the quotient, which is obtained by dividing Pₘ′ at Step 4 by ω₀.

At Step 6, the speed feedback coefficient K is set according to the rotation speed difference Δω obtained at Step 5.

At Step 7, a CLARK transform is performed by means of the excitation electromotive force e obtained at Step 3 according to the formula (11) to obtain voltages e_{α} and e_{β} in a α-β stationary coordinate system:

$$[ \begin{matrix}{e}_{α} \\ {e}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] e = \sqrt{\frac{2}{3}} [ \begin{matrix}1 & - \frac{1}{2} \\ 0 & \frac{\sqrt{3}}{2}\end{matrix} \qquad ( 11 )$$

At Step 8, taking the voltages e_{α} and e_{β} obtained at Step 7 as the input parameters, Space Vector Pulse Width Modulation (SVPWM) is performed to obtain a six-way switch control pulse driving the three-phase full-bridge inverter to implement a three-phase Alternating Current (AC) current feedback grid.

The beneficial effect of at least some embodiments of the present disclosure is that by introducing output speed feedback control, a convenient and feasible means is provided for improving transient stability. Adaptive control policies of speed feedback coefficient based on frequency characteristics of different stages shorten the time of transient regulation, and ensure that in a transient regulation process, a deviation of system frequency is in the accepted range as well as suppressing power overshoot without changing the parameter Dₚ and the parameter J (namely without changing the requirement of the system for the energy storage margin), specifically including the following aspects.

One, based on analyzing transient characteristics of the VSG, adaptive control rules of an output speed feedback system are designed aiming at different phases of the transient adjustment.

Two, an output speed feedback is used for controlling the damping of the system, so as to make the system work under an over-damping characteristic, prevent an energy storage device from charging and discharging frequently and repeatedly, and prevent the power overshoot from having an adverse impact on an electrical device. At the same time, a frequency fluctuation range in a dynamic regulation process is limited, and it is ensured that the VSG will not separate from the grid due to the frequency over-limit in the dynamic process.

Three, because the output speed feedback control is adopted, the power overshoot in the dynamic process may be effectively suppressed and the dynamic performance may be improved without adjusting a damping droop coefficient and a virtual rotational inertia in a large scale.

### BRIEF DESCRIPTION OF THE DRAWINGS

FIG. 1 is a block diagram of a hardware system on which a method of the present disclosure depends according to an embodiment of the present disclosure.

FIG. 2 is a block diagram of speed feedback control adopted by a method according to an embodiment of the present disclosure (corresponding to Step 4).

FIG. 3 is a comparison experiment curve of system output active power responses of a method in the present disclosure and the other existing adaptive control methods according to an embodiment of the present disclosure.

FIG. 4 is a comparison experiment curve of system output frequency responses of a method in the present disclosure and the other existing adaptive control methods according to an embodiment of the present disclosure.

### DETAILED DESCRIPTION

The present disclosure is elaborated below in combination with the accompanying drawings and specific implementation modes.

Adaptive control policies of a method in an embodiment of the present disclosure are featured in: with a view to the damage of a system frequency and a power rush to a power electronic device in a transient process, damping of an output speed feedback regulation system is introduced, and the transient performance is optimized by adjusting in real time an output speed feedback coefficient without changing a parameter J and a parameter Dₚ, thereby suppressing the power overshoot, limiting a threshold of system frequency variation in a dynamic process, and effectively preventing the VSG from separating from the grid due to the frequency variation.

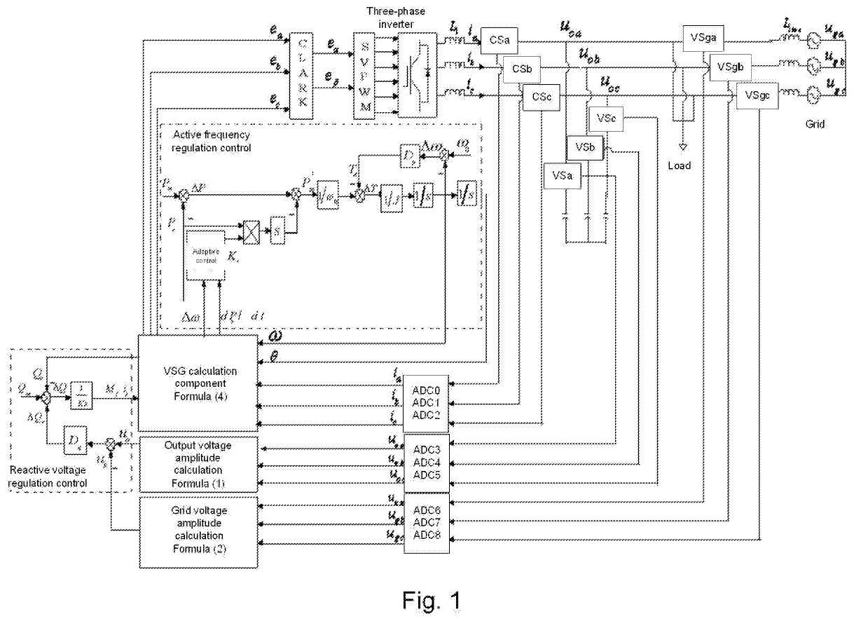

As shown in FIG. 1, a system structure on which an adaptive control method of a VSG in the present disclosure depends includes a three-phase full-bridge inverter. An output end of the three-phase full-bridge inverter is connected to the grid through an LC filter circuit. A group of current sensors (CSa, CSb and CSc in FIG. 1) and two groups of voltage sensors (VSa, VSb and VSc as shown in FIG. 1; VSga, VSgb and VSgc as shown in FIG. 1) are set on a grid-connected three-phase circuit. The two groups of voltage sensors respectively acquire a three-phase voltage signal and a three-phase grid voltage signal output by the three-phase full-bridge inverter, and obtain corresponding digital values by their own A/D (analog-digital conversion component). The digital values are respectively input in an output voltage amplitude calculation (component) and a grid voltage amplitude calculation (component), and then a voltage amplitude uₒ and a grid voltage amplitude u_{g} are calculated. The voltage amplitude uₒ and the grid voltage amplitude u_{g} are input in a reactive voltage regulation control (component), and then a virtual synchronous excitation signal M_{f}i_{f} is calculated. The digital values obtained after the virtual synchronous excitation signal M_{f}i_{f} output by the reactive voltage regulation control (component), angular speed ω and phase θ of the VSG output by an active frequency regulation control (component), and an output current of the three-phase full-bridge inverter acquired by the current sensor pass through the A/D (component) are input in a VSG calculation component. An output quantity of the VSG calculation component is reactive power Qₑ which is connected to the reactive voltage regulation control (component), another output quantity of the VSG calculation component is active power Pₑ which is connected to the active frequency regulation control (component), and the third output quantity of the VSG calculation component is an excitation electromotive force Qₑ which is input in SVPWM (namely a SWPWM component) after the CLARK transform, thereby obtaining a control signal of the three-phase full-bridge inverter. As shown in FIG. 1, “1/s” is a complex frequency domain representing symbol of an integral, and “s” is a complex variable representing symbol of the Laplace transform. The full name of the reactive voltage regulation control is reactive power-voltage regulation control, and the full name of an active frequency regulation control loop is active power-frequency regulation control.

Based on the above structure principle, the control method of the present disclosure is implemented according to the following steps.

At Step 1, output currents, output voltages and grid voltages of a three-phase full-bridge inverter are acquired through a current sensor and a voltage sensor, and analog signals is converted, through a conversion circuit, to digital values iₐ, i_{b} and i_{c} corresponding to the output currents, digital values uₒₐ, u_{ob} and u_{oc} corresponding to the output voltages, and digital values u_{ga}, u_{gb} and u_{gc} corresponding to the grid voltages.

In this embodiment as shown in FIG. 1, output three-phase currents, output three-phase voltages and grid three-phase voltages of the three-phase full-bridge inverter are respectively acquired through three current sensors (namely CSa, CSb and CSc) and two groups of voltage sensors (six in all, namely VSa, VSb, VSc and VSga, VSgb, VSgc), and the digital values iₐ, i_{b} and i_{c} corresponding to these analog variables, output voltage three-phase signals uₒₐ, u_{ob} and u_{oc}, and grid voltage three-phase signals u_{ga}, u_{gb} and u_{gc} are respectively obtained through their own analog-digital conversion circuits (the analog-digital conversion circuits are namely the ADC0, ADC1, ADC2; ADC3, ADC4, ADC5; ADC6, ADC7, ADC8 as shown in FIG. 1, and the AD component from a TMS320F28335 controller).

At Step 2, VSG excitation M_{f}i_{f} output by inactive power-voltage regulation control is calculated, and an output voltage amplitude uₒ and a grid voltage amplitude u_{g} of the three-phase full-bridge inverter are calculated.

By means of the output voltage three-phase signals uₒₐ, u_{ob} and u_{oc} and the grid voltage three-phase signals u_{ga}, u_{gb} and u_{gc} obtained at Step 1, the output voltage amplitude uₒ and the grid voltage amplitude u_{g} are obtained through an amplitude detection loop. As shown in the formula (1) and the formula (2), the calculation process includes that: a reactive power regulating variable ΔQᵥ corresponding to a voltage fluctuation is obtained by calculating a difference between the output voltage amplitude uₒ and the grid voltage amplitude u_{g}, and then multiplying the difference by a voltage droop coefficient D_{q}; a variable quantity ΔQ of the total reactive power is obtained by adding the reactive power regulating variable ΔQᵥ to a difference obtained by subtracting an actual reactive power Qₑ from a given reactive power Qₘ; an excitation signal M_{f}i_{f} of the VSG is obtained by integrating the variable quantity ΔQ after a proportional element of a gain

$$\frac{1}{K} ( \frac{1}{s}$$

(in FIG. 1 represents an integrating operation, and

$$\frac{1}{Ks}$$

represents an integral after a gain loop

$$\frac{1}{K} ) ,$$

as shown in the formula (3);

$$\begin{matrix}{u}_{o} = \sqrt{- \frac{4}{3} ( {u}_{oa} {u}_{ob} + {u}_{ob} {u}_{oc} + {u}_{oc} {u}_{oa} )} & ( 1 ) \\ {u}_{g} = \sqrt{- \frac{4}{3} ( {u}_{ga} {u}_{gb} + {u}_{gb} {u}_{gc} + {u}_{gc} {u}_{ga} )} & ( 2 ) \\ {M}_{f} {i}_{f} = \int \frac{{D}_{q} ( {u}_{o} - {u}_{g} ) + ( {Q}_{m} - {Q}_{e} )}{K} dt = \int \frac{Δ {Q}_{v} + ( {Q}_{m} - {Q}_{e} )}{K} dt = \int \frac{Δ Q}{K} dt & ( 3 )\end{matrix}$$

In the embodiment as shown in FIG. 1, the digital values corresponding to the output voltages and the grid voltages acquired by a digital signal processor AD component are respectively substituted into the formula (1) and the formula (2) to obtain the output voltage amplitude uₒ and the grid voltage amplitude u_{g}. At the same time, the excitation signal M_{f}i_{f} of the VSG is obtained by means of the formula (3). The values of the voltage droop coefficient D_{g} and an integral gain K are shown in Table 1.

At Step 3, an active power Pₑ, a reactive power Qₑ and an excitation electromotive force e output by the VSG are calculated; the calculation process is as shown in the formula (4):

$$\{ \begin{matrix}{P}_{e} = ω {M}_{f} {i}_{f} {i}^{T} S \\ {Q}_{e} = - ω {M}_{f} {i}_{f} {i}^{T} C \\ e = ω {M}_{f} {i}_{f} S\end{matrix} \qquad ( 4 )$$

in the formula (4), ω and θ are respectively output signal virtual angular velocity and phase of an active frequency modulation control loop; the excitation electromotive force e=[eₐ, e_{b} e_{c}]^{T}; a three-phase stator current i=[iₐ i_{b} i_{c}]^{T} is obtained at Step 1; the excitation signal M_{f}i_{f} of the VSG is obtained at Step 2;

$$C = {[ \begin{matrix}\begin{matrix}cos θ & cos\end{matrix} ( θ - \frac{2 π}{3} ) & cos\end{matrix} ( θ - \frac{4 π}{3} ) ]}^{T} ;$$

$$S = {[ \begin{matrix}\begin{matrix}sin θ & sin\end{matrix} ( θ - \frac{2 π}{3} ) & sin\end{matrix} ( θ - \frac{4 π}{3} ) ]}^{T} ;$$

and the T represents a vector transpose operation.

At Step 4, speed feedback control is performed, and an initial value of a velocity feedback coefficient Kₜ is calculated.

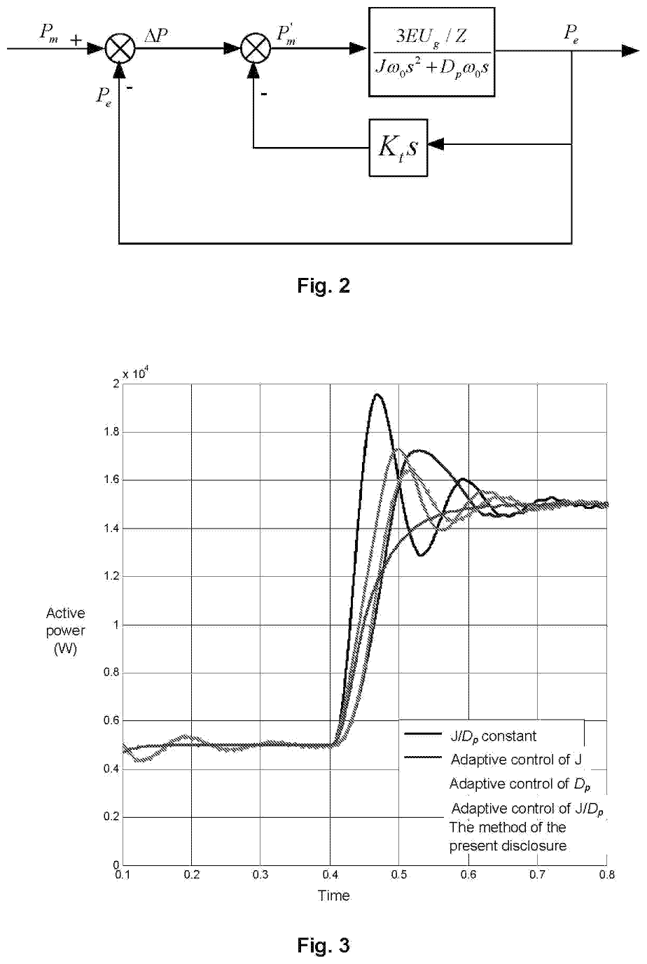

FIG. 2 shows the control block diagram, and the transfer function in the control block diagram represents an open-loop transfer function of the active frequency regulation control loop.

An error signal ΔP is obtained by subtracting the active power Pₑ obtained at Step 3 from a given mechanical power Pₘ. A difference between the error signal ΔP and an electromagnetic power Pₑ of the VSG is calculated. The difference is taken as an input of a derivative feedback loop Kₜs to obtain an output of the derivative feedback loop Kₜs. The output is taken as a control quantity of an active frequency regulation control loop, as shown in the formula (5), and the velocity feedback coefficient Kₜ is calculated according to the formula (6).

$$\begin{matrix}{P}_{m}^{′} = {P}_{m} - {P}_{e} - {K}_{t} \frac{d {P}_{e}}{dt} = Δ P - {K}_{t} \frac{{dP}_{e}}{dt} & ( 5 ) \\ {K}_{t} = \frac{2 ζ \sqrt{{H}_{p δ} ( s ) J {ω}_{0}} - {D}_{p} {ω}_{0}}{{H}_{p δ} ( s )} & ( 6 )\end{matrix}$$

where ζ is a system damping ratio, J is a system virtual rotational inertia, Dₚ is an active frequency modulation droop coefficient, and ωₒ is a system expected frequency value. And an active power to angular transfer function is

$${H}_{p δ} ( s ) = \frac{3 {EU}_{g}}{Z} ,$$

Z is a system impedance, U_{g} is an effective value of grid phase voltage, and E is a steady-state excitation voltage. The values of the variables are calculated according to the formula (7):

$$\{ \begin{matrix}Z = \sqrt{{X}^{2} + {R}^{2}} = \sqrt{{( ( {L}_{1} + {L}_{line} ) {ω}_{0} )}^{2} + ( {R}_{1} + {R}_{li}} \\ α = arctan \frac{X}{R} \\ δ = α - arctan \frac{\frac{{Q}_{m}}{3} Z + {U}_{g}^{2} sin α}{\frac{{P}_{m}}{3} Z + {U}_{g}^{2} cos α} \\ E = \frac{\frac{{Q}_{m}}{3} Z + {U}_{g}^{2} sin α}{{U}_{g} sin ( α - δ )}\end{matrix} \qquad ( 7 )$$

where X is an inductance of the system impedance, R is a resistance of the system impedance, L₁ is a filter inductance of an inverter side, Lₗᵢₙₑ is a line inductance of the grid side, R₁ is a parasitic resistance of L₁, Rₗᵢₙₑ is the parasitic resistance of Lₗᵢₙₑ, α is a system impedance angle, and δ is a system power angle.

Thus, in the digital signal processor (TMS320F28335) as shown in FIG. 1, Pₘ′ is obtained according to the formula (5), and an active power angle transfer function value H_{Pδ}(s) is determined according to the formula (6) and the formula (7).

For the embodiment in FIG. 1, L₁=6×10⁻³H; Lₗᵢₙₑ=2×10⁻³H; R₁=0.1Ω; Rₗᵢₙₑ=0.6n; Qₘ=6000 Var; Pₘ=5000 W; grid voltage U_{g}=220V; then, calculated values of the following variables are obtained:

$$\{ \begin{matrix}Z = \sqrt{{( ( 6 \times {10}^{- 3} + 2 \times {10}^{- 3} ) \times 2 π \times 50 )}^{2} + {( 0.1 + 0.6 )}^{2}} = 2.61 \\ α = arctan \frac{( 6 \times {10}^{- 3} + 2 \times {10}^{- 3} ) \times 2 π \times 50}{0.1 + 0.6} = 1.3 \\ δ = 1.3 - arctan \frac{\frac{6000}{3} \times 2.61 + {220}^{2} \times sin 1.3}{\frac{5000}{3} 2.61 + {220}^{2} \times cos 1.3} \\ E = \frac{\frac{6000}{3} \times 2.61 + {220}^{2} \times sin 1.3}{220 \times sin ( 1.3 - 0.051 )}\end{matrix} \\ {H}_{p δ} ( s ) = \frac{3 {EU}_{g}}{Z} = \frac{3 \times 248.47 \times 220}{2.61} = 62831$$

The initial value of the output speed feedback coefficient Kₜ is determined by the formula (6). In the embodiment, the damping ζ of system is set to be equal to 1.1, then:

$${K}_{t} = \frac{2 \times 1.1 \sqrt{62831 \times 0.0437 \times 2 π \times 50} - 2.533 \times 2 π \times 50}{62831} = 0.0198 ∘$$

At Step 5, the active power-frequency modulation control is performed, the angular velocity ω and phase θ of the VSG are output, and the rotation speed difference Δω and an angular acceleration

$$\frac{d ω}{dt}$$

of the VSG are calculated.

The angular acceleration

$$\frac{d ω}{dt}$$

of the VSG is obtained according to the formula (8). The angular acceleration

$$\frac{d ω}{dt}$$

of the VSG is integrated to obtain the angular velocity ω of the VSG. And then the angular velocity ω of the VSG is integrated to obtain the phase θ of the VSG.

$$\frac{d ω}{d t} = \frac{\frac{{P}_{m}^{′}}{{ω}_{0}} - {D}_{p} ( ω - {ω}_{0} )}{J} = \frac{\frac{{P}_{m}^{′}}{{ω}_{0}} - {T}_{d}}{J} = \frac{Δ T}{J} \qquad ( 8 )$$

where a damping torque T_{d}=Dₚ(ω−ω₀); a torque variation ΔT is obtained by subtracting the damping torque T_{d} from the quotient, which is obtained by dividing Pₘ′ in S4 by ω₀.

At Step 6, according to the rotation speed difference Δω obtained at Step 5, an adaptive regulating rule of the velocity feedback coefficient Kₜ is set as follows:

6.1) if Δω<2πΔfₘₐₓ, then the speed feedback coefficient Kₜ is calculated according to the formula (6), and selection mode of damping ζ is as shown in the formula (9):

$$ζ = \{ \begin{matrix}1.12 , & \vert Δ f \vert < {f}_{stable} and N > T \\ 1.37 , & 0.05 < \vert Δ f \vert < 0.5 or ( \vert Δ f \vert < {f}_{stable} and N < T )\end{matrix} \qquad ( 9 )$$

where N is a counter, and T is a threshold value, and when the counter N>T, a system steady state is to be entered;

6.2) if Δω>2πΔfₘₐₓ, then the velocity feedback coefficient Kₜ is calculated according to the formula (10):

$${K}_{t} = \frac{{P}_{m} - {P}_{e} - {ω}_{0} {D}_{p} ( ω - {ω}_{0} )}{\frac{{dP}_{e}}{dt}} \qquad ( 10 )$$

According to the above embodiment, an initial active power of the VSG system is 5000 W, the reactive power is 6000 Var. When the time is 0.4 s, the active power changes to 15000 W, the reactive power remains constant, and it is set that Δfₘₐₓ=0.5; the acquired Δω and dω/dt signal are input in the digital signal processor to be determined, and the speed feedback coefficient K is determined as follows:

if Δω<2πΔfₘₐₓ, the speed feedback coefficient Kₜ is calculated according to the formula (6); the damping selection may be adjusted according to the actual situation; in the embodiment, the damping 4 selection is as shown in the formula (9);

if Δω>2πΔfₘₐₓ, then the speed feedback coefficient Kₜ is calculated according to the formula (10).

At Step 7, the CLARK transform is performed by means of the excitation electromotive force e obtained at Step 3 according to the formula (11) to obtain voltages e_{α} and e_{β} in an α-β stationary coordinate system, namely:

$$[ \begin{matrix}{e}_{α} \\ {e}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] e = \sqrt{\frac{2}{3}} [ \begin{matrix}1 & - \frac{1}{2} \\ 0 & \frac{\sqrt{3}}{2}\end{matrix} ] \qquad ( 11 )$$

At Step 8, taking the voltages e_{α} and e_{β} obtained at Step 7 as the input, SVPWM is performed to obtain a six-way switch control pulse driving the three-phase full-bridge inverter (namely a pulse quantity driving six switch tubes of the three-phase full-bridge inverter) and implement a three-phase AC current feedback grid.

Contrast of Implementation Effects:

the parameters J and Kₜ are updated by means of an output quantity of an adaptive controller, and the method of the present disclosure is verified through Matlab/Simulink; at the same time, in order to state the validity of the control method of the present disclosure, a comparison experiment is set. In the experiment, several different control methods are adopted to control the VSG to work:

\textcircled{1} constant control method of J and Dₚ (references [1,2], [1]Q. C. Zhong and G. Weiss, “Synchronverters: Inverters That Mimic Synchronous Generators,” IEEE Transactions on Industrial Electronics, vol. 58, no. 4, pp. 1259-1267, April 2011. [2]Q. C. Zhong, “Virtual Synchronous Machines: A unified interface for grid integration,” IEEE Power Electronics Magazine, vol. 3, no. 4, pp. 18-27, December 2016.);

\textcircled{2} an adaptive control method of J (references [3,4], [3]J. Alipoor, Y. Miura, T. Ise.

Power System Stabilization Using Virtual Synchronous Generator With Alternating Moment of Inertia. IIEEE Journal of Emerging and Selected Topics in Power Electronics, 3(2): 451-458, June 2015; [4]J. Alipoor, Y. Miura, T. Ise. Distributed generation grid integration using virtual synchronous generator with adoptive virtual inertia. In: 2013 IEEE Energy Conversion Congress and Exposition. Denver, Colo.: IEEE, 2013. pp. 4546-4552.);

\textcircled{3} an adaptive control method of Dₚ (references [5], [5]T. Zheng, L. Chen, R. Wang, C. Li and S. Mei. Adaptive damping control strategy of virtual synchronous generator for frequency oscillation suppression. In: Proceedings of the 12th IET International Conference on AC and DC Power Transmission (ACDC 2016), Beijing, China: 2016. pp. 1-5);

\textcircled{4} the adaptive control of J and Dₚ (references [6,7], [6]D. Li, Q. Zhu, S. Lin and X. Y. Bian. A Self-Adaptive Inertia and Damping Combination Control of VSG to Support Frequency Stability. IEEE Transactions on Energy Conversion, 32(1): 397-398, January 2017; [7]W. Fan, X. Yan and T. Hua. Adaptive parameter control strategy of VSG for improving system transient stability. 2017 IEEE 3rd International Future Energy Electronics Conference and ECCE Asia (IFEEC 2017—ECCE Asia). Kaohsiung: 2017, pp. 2053-2058.).

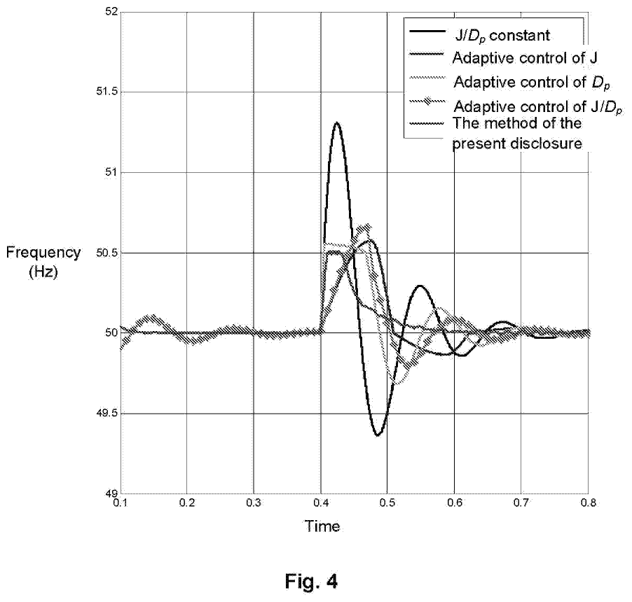

FIG. 3 and FIG. 4 illustrate comparison curves of a Simulink simulation result. FIG. 3 is the power regulation process of different control methods, in which the abscissa is time, and the ordinate is an input mechanical power. FIG. 4 is the frequency regulation process of different control methods, in which the abscissa is time, and the ordinate is the system frequency.

Table 1 shows the settings of main parameters of the Matlab/Simulink simulation.

TABLE 1
Main simulation parameters

| Parameters | Selected values |
|---|---|
| Initial value J0 of virtual rotational | 0.0437 |
| inertia | |
| Integral gain K | 1.9912e+03 |
| Damping droop coefficient Dₚ | 2.533 |
| Voltage droop coefficient Dq | 192.8473 |

Table 2 shows comparison results of different control methods.

TABLE 2
Comparison results of different control methods

| | Performance index | | |
|---|---|---|---|
| | Maximum | Peak value of | |
| Different | power | system | Regulation |
| control methods | overshoot (%) | frequency (Hz) | time (s) |
| Constant control of J | 30 | 51.30 | 0.32 |
| and Dₚ | | | |
| Adaptive control of J | 14.67 | 50.57 | 0.28 |
| Adaptive control of Dₚ | 15.33 | 50.56 | 0.24 |
| Adaptive control of J | 10 | 50.65 | 0.26 |
| and Dₚ | | | |
| The method of the | 0 | 50.5 | 0.20 |
| present disclosure | | | |

The comparison experiment shows that the method of the present disclosure may completely suppress the power overshoot and improve the dynamic performance of the system; at the same time, the method of the present disclosure may limit a change threshold of the system frequency. It can be seen by comparing with other methods that the method of the present disclosure limits the maximum frequency variation (which is less than 0.5) of the transient frequency regulation process, at the same time, the power regulation presents an over-damped state in the regulation process, thereby preventing an energy storage device from charging and discharging frequently and repeatedly, and preventing a power (voltage) rush on the device.

What is claimed is:

1. An adaptive control method for an output feedback of a Virtual Synchronous Generator (VSG), comprising:
Step 1, acquiring output currents, output voltages and grid voltages of a three-phase full-bridge inverter through a current sensor and a voltage sensor, converting analog signals to digital values iₐ, i_{b} and i_{c} corresponding to the output currents, digital values uₒₐ, u_{ob} and u_{oc} corresponding to the output voltages, and digital values u_{ga}, u_{gb} and u_{gc} corresponding to the grid voltages;
Step 2, calculating VSG excitation M_{f}i_{f} output by inactive power-voltage regulation control, and calculating an output voltage amplitude uₒ and a grid voltage amplitude u_{g} of the three-phase full-bridge inverter;
Step 3, calculating an active power Pₑ, a reactive power Qₑ and an excitation electromotive force e output by the VSG;
Step 4, performing speed feedback control, and calculating an initial value Kₜ of a speed feedback coefficient;
Step 5, implementing active power-frequency modulation control, outputting a angular speed ω and a phase of the VSG, calculating a rotation speed difference Δω, obtaining an angular acceleration
$$\frac{d ω}{d t}$$
of the VSG according to the formula (8); integrating the angular acceleration
$$\frac{d ω}{d t}$$
of the VSG to obtain the angular speed ω of the VSG, and then integrating the angular speed ω of the VSG to obtain the phase θ of the VSG;
$$\frac{d ω}{d t} = \frac{\frac{{P}_{m}^{′}}{{ω}_{0}} - {D}_{p} ( ω - {ω}_{0} )}{J} = \frac{\frac{{P}_{m}^{′}}{{ω}_{0}} - {T}_{d}}{J} = \frac{Δ T}{J} \qquad ( 8 )$$
wherein a damping torque T_{d}=Dₚ(ω−ω₀), the damping torque T_{d} is subtracted from the quotient, which is obtained by dividing Pₘ′ obtained at Step 4 by ω₀, to obtain a torque variable quantity ΔT;
Step 6, setting the speed feedback coefficient Kₜ according to the rotation speed difference Δω obtained at Step 5;
Step 7, performing a CLARK transform by means of the excitation electromotive force e obtained at Step 3 according to the formula (11) to obtain voltages e_{α} and e_{β} in a α-β stationary coordinate system:
$$[ \begin{matrix}{e}_{α} \\ {e}_{β}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2}\end{matrix} ] e = \sqrt{\frac{2}{3}} [ \begin{matrix}1 & - \frac{1}{2} \\ 0 & \frac{\sqrt{3}}{2}\end{matrix} ] \qquad ( 11 )$$
Step 8, taking the voltages e_{α} and e_{β} obtained at Step 7 as input parameters, performing Space Vector Pulse Width Modulation (SVPWM) to obtain a six-way switch control pulse driving the three-phase full-bridge inverter to implement a three-phase Alternating Current (AC) current feedback grid.

2. The adaptive control method for the output feedback of the VSG as claimed in claim 1, wherein at Step 2, by means of output voltage three-phase signals uₒₐ, u_{ob} and u_{oc} and grid voltage three-phase signals u_{ga}, u_{gb} and u_{gc} obtained at Step 1, obtaining the output voltage amplitude uₒ and the grid voltage amplitude u_{g} through an amplitude detection loop; the calculation process is as shown in formula (1) and formula (2);
obtaining a reactive power regulating variable ΔQᵥ corresponding to a voltage fluctuation by calculating a difference between the output voltage amplitude uₒ and the grid voltage amplitude u_{g}, and then multiplying the difference by a voltage droop coefficient D_{q}, and then adding the reactive power regulating variable ΔQᵥ to a difference obtained by subtracting an actual reactive power Qₑ from a given reactive power Qₘ to obtain a variable quantity ΔQ of the total reactive power; integrating the variable quantity ΔQ after a proportional element of a gain
$$\frac{1}{K}$$
to obtain an excitation signal M_{f}i_{f} of the VSG, as shown in the formula (3);
$$\begin{matrix}{u}_{o} = \sqrt{- \frac{4}{3} ( {u}_{oa} {u}_{ob} + {u}_{ob} {u}_{oc} + {u}_{oc} {u}_{oa} )} & ( 1 ) \\ {u}_{g} = \sqrt{- \frac{4}{3} ( {u}_{ga} {u}_{gb} + {u}_{gb} {u}_{gc} + {u}_{gc} {u}_{ga} )} & ( 2 ) \\ {M}_{f} {i}_{f} = \int \frac{{D}_{q} ( {u}_{o} + {u}_{g} ) + ( {Q}_{m} - {Q}_{e} )}{K} dt = \int \frac{Δ {Q}_{v} + ( {Q}_{m} - {Q}_{e} )}{K} dt = \int \frac{Δ Q}{K} dt & ( 3 )\end{matrix}$$

3. The adaptive control method for the output feedback of the VSG as claimed in claim 2, wherein at Step 4, the calculation process is as shown in the formula (4):
$$\{ \begin{matrix}{P}_{e} = ω {M}_{f} {i}_{f} {i}^{T} S \\ {Q}_{e} = - ω {M}_{f} {i}_{f} {i}^{T} C \\ e = ω {M}_{f} {i}_{f} S\end{matrix} \qquad ( 4 )$$
wherein in the formula (4), ω and θ are respectively output signal virtual angular speed and phase of an active frequency modulation control loop, the excitation electromotive force e=[eₐ e_{b} e_{c}]^{T}, a three-phase stator current i=[iₐ i_{b} i_{c}]^{T} is obtained at Step 1, the excitation signal M_{f}i_{f} of the VSG is obtained at Step 2,
$$C = {⌊ \begin{matrix}cos θ & cos ( θ - \frac{2 π}{3} ) & cos ( θ - \frac{4 π}{3} )\end{matrix} ⌋}^{T} , \\ S = {[ \begin{matrix}sin θ & sin ( θ - \frac{2 π}{3} ) & sin ( θ - \frac{4 π}{3} )\end{matrix} ]}^{T} ,$$
and the T represents a vector transpose operation.

4. The adaptive control method for the output feedback of the VSG as claimed in claim 3, wherein at Step 4, calculating the initial value Kₜ of the speed feedback coefficient comprises:
subtracting the active power Pₑ obtained at Step 3 from a given mechanical power Pₘ to obtain an error signal ΔP, calculating a difference between the error signal ΔP and an electromagnetic power Pₑ of the VSG, taking the difference as an input of a derivative feedback loop Kₜs to obtain an output of the derivative feedback loop Kₜs, taking the output as a control quantity Pₘ′ of an active frequency regulation control loop, as shown in the formula (5), and calculating the speed feedback coefficient Kₜ is according to the formula (6);
$$\begin{matrix}{P}_{m}^{′} = {P}_{m} - {P}_{e} - {K}_{t} \frac{d {P}_{e}}{dt} = Δ P - {K}_{t} \frac{d {P}_{e}}{dt} & ( 5 ) \\ {K}_{t} = \frac{2 ζ \sqrt{ {H}_{p δ} ( s ) J {ω}_{0}} - {D}_{p} {ω}_{0}}{{H}_{p δ} ( s )} & ( 6 )\end{matrix}$$
wherein ζ is a system damping ratio, J is a system virtual rotational inertia, Dₚ is an active frequency modulation droop coefficient, and ωₒ is a system expected frequency value;
wherein an active angular transfer function is
$${H}_{p δ} ( s ) = \frac{3 {EU}_{g}}{Z} ,$$
Z is a system impedance, Ug is an effective value of grid phase voltage, E is a steady-state excitation voltage, values of these variables are calculated according to the formula (7):
$$\{ \begin{matrix}Z = \sqrt{{X}^{2} + {R}^{2}} = \sqrt{{( ( {L}_{1} + {L}_{line} ) {ω}_{0} )}^{2} + {( {R}_{1} + {R}_{line} )}^{2}} \\ α = arctan \frac{X}{R} \\ δ = α - arctan \frac{\frac{{Q}_{m}}{3} Z + {U}_{g}^{2} sin α}{\frac{{P}_{m}}{3} Z + {U}_{g}^{2} cos α} \\ E = \frac{\frac{{Q}_{m}}{3} Z + {U}_{g}^{2} sin α}{{E}_{g} sin ( α - δ )}\end{matrix} \qquad ( 7 )$$
wherein X is an inductance of the system impedance, R is a resistance of the system impedance, L₁ is a filter inductance of an inverter side, Lₗᵢₙₑ is a line inductance of the grid side, R₁ is a parasitic resistance of L₁, Rₗᵢₙₑ is the parasitic resistance of Lₗᵢₙₑ, α is a system impedance angle, and δ is a system power angle.

5. The adaptive control method for the output feedback of the VSG as claimed in claim 4, wherein at Step 6, setting an adaptive regulation rule of the speed feedback coefficient Kₜ as follows:
when Δω<2πΔfₘₐₓ, calculating the speed feedback coefficient Kₜ according to the formula (6) wherein a selection mode of damping ζ is as shown in the formula (9):
$$ζ = \{ \begin{matrix}1.12 , & \vert Δ f \vert < {f}_{stable} and N > T \\ 1.37 , & 0.05 < \vert Δ f \vert < 0.5 or ( \vert Δ f \vert < {f}_{stable} and N < T )\end{matrix} \qquad ( 9 )$$
wherein N is a counter, T is a threshold value, and when the counter N>T, a system steady state is to be entered;
when Δω>2πΔfₘₐₓ, calculating the speed feedback coefficient Kₜ according to the formula (10):
$${K}_{t} = \frac{{P}_{m} - {P}_{e} - {ω}_{0} {D}_{p} ( ω - {ω}_{0} )}{\frac{d {P}_{e}}{dt}} . \qquad ( 10 )$$
